(19) United States
(12) Patent Application Publication
(10) Pub. No.: US 2017/0226389 A1
(43) Pub. Date: Aug. 10, 2017

(54) Adhesive Arrangement

(71) Applicant: Tyco Electronics Corporation, Berwyn, PA (US)

(72) Inventors: Lei Wang, San Jose, CA (US); Hyo Chang Yun, Saratoga, CA (US); Peter J. Dutton, Fremont, CA (US)

(73) Assignee: Tyco Electronics Corporation, Berwyn, PA (US)

(21) Appl. No.: 15/040,993

(22) Filed: Feb. 10, 2016

(51) Int. Cl. C09J 127/12; B32B 27/00; B32B 15/00; C09J 7/02; B32B 7/12

(52) U.S. Cl. CPC C09J 127/12; C09J 7/0292; C09J 7/0267; B32B 7/12; B32B 15/00; B32B 27/00; C09J 2427/00; C09J 2427/006; B32B 2250/02; B32B 2255/26

(57) ABSTRACT

An adhesive arrangement includes an adhesive formed from an adhesive composition, the adhesive composition having a fluoropolymeric material, a functionalized fluoropolymeric material, and a thermoplastic material, and a base layer in contact with the adhesive, the base layer being a perfluoropolymeric material, a composite material, a metal material, or a metallic material. The thermoplastic material is selected from the group consisting of polyamide (PA), polyphenylenesulfide (PPS), polyetheretherketone (PEEK), polyimide (PI), polyimide derivatives such as polyetherimide (PEI), polyaryletherketone (PAEK), polyaryletherketone derivatives, polysulfone, polyethersulfone (PES), polysulfone derivatives, and combinations thereof.

### FIELD OF THE INVENTION

The present invention is generally directed to adhesives. More particularly, the present invention is directed to adhesive arrangements having at least one layer in contact with an adhesive blend.

### BACKGROUND OF THE INVENTION

Many adhesives bond well to various metals. However, bonding to perfluoropolymers, such as polytetrafluoroethylene (PTFE), is difficult due to their low surface energy, high crystallinity, and chemical resistance. To address this, perfluoropolymers are often surface treated prior to bonding, such as, chemical etching, plasma treating, or flame treatment. While surface treatments may facilitate bonding to PTFE, adhesives capable of bonding a metal to a perfluoropolymer surface suffer from various difficulties, in part due to the difficulty in bonding to perfluoropolymers and in part due to the differences in surface energy of metal (around 2 J/m²) and the surface energy of PTFE (around 0.02 J/m²).

In addition, certain applications are not suitable for surface treatment. For example, repair environments can be incompatible with the operational needs of surface treatment techniques. As such, there remains a need for an adhesive capable of bonding perfluoropolymers and metals without surface treatment of the perfluoropolymers. One formulation currently being explored for this purpose includes a perfluoropolymer and thermoplastic blend. However, these blends generally display weak peel strength, which may limit their applicability.

An adhesive arrangement that shows one or more improvements in comparison to the prior art would be desirable in the art.

### BRIEF DESCRIPTION OF THE INVENTION

In an embodiment, an adhesive arrangement includes an adhesive formed from an adhesive composition, the adhesive composition having a fluoropolymeric material, a functionalized fluoropolymeric material, and a thermoplastic material, and a base layer in contact with the adhesive, the base layer being a perfluoropolymeric material, a composite material, a metal material, or a metallic material. The thermoplastic material is selected from the group consisting of polyamide (PA), polyphenylenesulfide (PPS), polyetheretherketone (PEEK), polyimide (PI), polyimide derivatives such as polyetherimide (PEI), polyaryletherketone (PAEK), polyaryletherketone derivatives, polysulfone, polyethersulfone (PES), polysulfone derivatives, and combinations thereof.

In another embodiment, an adhesive arrangement includes an adhesive formed from an adhesive composition, the adhesive composition having a fluoropolymeric material, a functionalized fluoropolymeric material, and a thermoplastic material, a base layer in contact with the adhesive, the base layer being selected from the group consisting of a perfluoropolymeric material, a composite material, a metal material, and a metallic material, and an adhering layer in contact with the adhesive and secured to the base layer by the adhesive, the adhering layer being selected from the group consisting of a perfluoropolymeric material, a composite material, a metal material, and a metallic material. The fluoropolymeric material is a melt-processable perfluoropolymeric material selected from the group consisting of perfluoroalkoxy (PFA), fluorinated ethylene propylene (FEP), and combinations thereof.

In another embodiment, an adhesive arrangement includes an adhesive formed from an adhesive composition, the adhesive composition having a fluoropolymeric material, a functionalized fluoropolymeric material, and a thermoplastic material, and a base layer in contact with the adhesive, the base layer being selected from the group consisting of a perfluoropolymeric material, a composite material, a metal material, and a metallic material. The fluoropolymeric material is a melt-processable perfluoropolymeric material selected from the group consisting of perfluoroalkoxy (PFA), fluorinated ethylene propylene (FEP), and combinations thereof. The functionalized fluoropolymeric material is selected from the group consisting of epoxy functionalized fluoropolymeric material, epoxy functionalized perfluoropolymeric material, anhydride functionalized fluoropolymeric material, anhydride functionalized perfluoropolymeric material, and combinations thereof. The thermoplastic material is selected from the group consisting of polyamide (PA), polyphenylenesulfide (PPS), polyetheretherketone (PEEK), polyimide (PI), polyimide derivatives such as polyetherimide (PEI), polyaryletherketone (PAEK), polyaryletherketone derivatives, polysulfone, polyethersulfone (PES), polysulfone derivatives, and combinations thereof. The base layer is devoid of surface characteristics from surface treatment.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic view of a section view of an adhesive arrangement defining a tube, according to an embodiment of the disclosure.

Wherever possible, the same reference numbers will be used throughout the drawings to represent the same parts.

### DETAILED DESCRIPTION OF THE INVENTION

Provided is an adhesive arrangement. Embodiments of the present disclosure, for example, in comparison to concepts failing to include one or more of the features disclosed herein, permit an adhesive blend to bond to low surface energy materials without relying upon surface treatment, permit bonding with perfluoropolymers (for example, polytetrafluoroethylene (PTFE)), permit bonding with metals (for example, steel and aluminum), permit bonding two different materials (for example, bonding aluminum to PTFE, bonding PTFE to steel), permit an increase in shear strength of bonded materials, permit an increase in peel strength, permit other features and advantages that are apparent in the present disclosure, or a combination thereof.

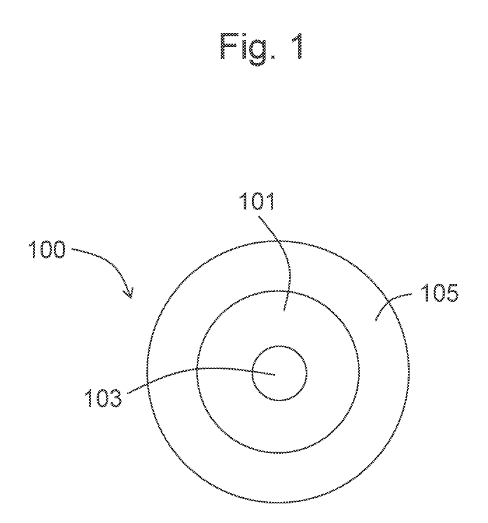

Referring to FIG. 1, an adhesive arrangement 100 includes an adhesive blend 101 and a base layer 103. In further embodiments, the adhesive arrangement 100 includes an adhering layer 105 directly or indirectly secured to the base layer 103 by the adhesive blend 101. The base layer 103 is a perfluoropolymeric material (for example, polytetrafluoroethylene), a composite material, a metal material, or a metallic material. The adhering layer 105 is the same material as the base layer 103 or is a different material from the base layer 103. Additionally or alternatively, in other embodiments, the adhesive blend 101 is present in one or more of the layers and/or abutting other adhesive layers, for example, as a gradient or transition.

In one embodiment, the base layer 103 and/or the adhering layer 105 are devoid or substantially devoid of surface characteristics from surface treatment, for example, by being devoid of surface morphology corresponding to plasma treatment (for example, by being devoid of a graft-polymerization layer, by being devoid of hydrophilicity corresponding with plasma treatment, and/or by being devoid of the near planar surface corresponding with plasma treatment), by being devoid of surface morphology corresponding to sodium-in-liquid-ammonium treatment (for example, by being devoid of chemical damage from such etching, by not being brown, and/or by not losing an optical penetration property), being devoid of surface restructuring from firing, or by being devoid of chemical or physical properties corresponding with surface treatment.

The adhesive blend 101 is formed from an adhesive composition. The adhesive composition includes a thermoplastic material, a fluoropolymeric material, and a functionalized fluoropolymeric material. In one embodiment, the thermoplastic material includes polyamide (PA), polyphenylenesulfide (PPS), polyetheretherketone (PEEK), polyimide (PI), polyimide derivatives such as polyetherimide (PEI), polyaryletherketone (PAEK), polyaryletherketone derivatives, polysulfone, polyethersulfone (PES), polysulfone derivatives, or a combination thereof. In another embodiment, the fluoropolymeric material includes a melt-processable perfluoropolymeric material such as, but not limited to, one or both of perfluoroalkoxy (PFA) and fluorinated ethylene propylene (FEP). As understood by those skilled in the art, the term “perfluoropolymeric” includes both perfluorinated and modified perfluorinated compounds. In a further embodiment, the functionalized fluoropolymeric material includes any suitable functionalized fluoropolymeric and/or perfluoropolymeric material, with a base material of the functionalized fluoropolymeric material (i.e., the functionalized fluoropolymeric material prior to functionalization) being the same as or different from the fluoropolymeric material. For example, suitable functionalized fluoropolymeric materials include, but are not limited to, epoxy functionalized fluoropolymeric and/or perfluoropolymeric material, anhydride functionalized fluoropolymeric and/or perfluoropolymeric material, or a combination thereof.

The adhesive blend includes any suitable combination of the thermoplastic material, the fluoropolymeric material, and the functionalized fluoropolymeric material, with each material forming any suitable percentage of the adhesive composition. In one embodiment, the thermoplastic material is at a concentration, by volume, of between 10% and 80%, between 10% and 50%, between 10% and 35%, between 20% and 40%, between 30% and 40%, or any suitable combination, sub-combination, range, or sub-range therein.

In one embodiment, the fluoropolymeric material is at a concentration, by volume, of between 20% and 90%, between 50% and 90%, between 65% and 90%, between 60% and 80%, between 60% and 70%, or any suitable combination, sub-combination, range, or sub-range therein.

In one embodiment, the functionalized fluoropolymeric material is at a concentration, by volume, of between 5% and 95%, between 10% and 90%, between 20% and 80%, between 10% and 50%, between 50% and 90%, between 20% and 40%, between 20% and 30%, between 65% and 90%, between 60% and 80%, between 60% and 70%, or any suitable combination, sub-combination, range, or sub-range therein.

The adhesive blend 101 permits the adhesive arrangement 100 to have a select shear strength. For example, depending upon the materials being adhered and the composition of the adhesive blend 101, the shear strength is at least 0.5 MPa, at least 1 MPa, at least 2.5 MPa, at least 3 MPa, at least 5 MPa, at least 8 MPa, at least 9 MPa, between 2 MPa to 10 MPa, a select percent above a relative shear strength of PFA (for example, at least 5% greater, at least 10% greater, at least 15% greater, at least 20% greater, at least 30% greater, at least 100% greater, at least 200% greater, and/or at least 300% greater) or any suitable combination, sub-combination, range, or sub-range therein.

Additionally or alternatively, the adhesive blend 101 permits the adhesive arrangement 100 to have a select peel strength. As used herein, the term “peel strength” refers to the bond strength between materials, which is the average load per unit width of bond line required to separate bonded materials at a defined angle of separation. For example, depending upon the materials being adhered and the composition of the adhesive blend 101, the peel strength is at least 1 lbf/in (i.e. 1 pound force per inch), at least 2 lbf/in, at least 5 lbf/in, at least 10 lbf/in, at least 15 lbf/in, at least 20 lbf/in, at least 25 lbf/in, at least 30 lbf/in, at least 35 lbf/in, between 1 and 35 lbf/in, between 5 and 30 lbf/in, between 5 and 25 lbf/in, a select percent above a relative peel strength of PFA and thermoplastic blends (for example, at least 50% greater, at least 100% greater, at least 200% greater, at least 500% greater, at least 1000% greater, at least 2000% greater) or any suitable combination, sub-combination, range, or sub-range therein.

Without wishing to be bound by theory, it is believed that the functional groups of the functionalized fluoropolymeric material reacts with the end groups of the thermoplastic material, this reaction increasing peel strength and providing increased miscibility of different phases. For example, in one or more of the embodiments disclosed herein, amine end groups of PEI react with epoxy functionalized fluoropolymers to increase peel strength of the adhesive blend 101 on metal and/or to increase miscibility of different phases. In another example, according to one or more of the embodiments disclosed herein, amine end groups of PEI react with anhydride functionalized fluoropolymers to increase peel strength of the adhesive blend 101 on metal and/or to increase miscibility of different phases. Additionally or alternatively, the functionalized fluoropolymeric material forms a compatibilizer, increasing interactions between the phases of the fluoropolymer and the thermoplastics. This increase in interaction provides increased miscibility and/or decreased phase separation of the different phases.

The adhesive blend 101 and/or the adhesive arrangement 100 further include any suitable features for desired properties. For example, in one embodiment, the adhesive blend 101 and/or the adhesive arrangement 100 includes filler particles. Suitable filler particles include, but are not limited to, reinforcing particles, conductive particles, or a combination thereof. In a further embodiment, where reinforcement is desired, the reinforcing particles in the adhesive blend 101 include reinforcing fibers and/or carbon fibers.

The adhesive arrangement 100 is positioned in, forms a portion of, or defines any suitable structure/article benefiting from adhesive properties, such as, the shear strength achievable by the adhesive blend 101. Suitable structures/articles include, but are not limited to, adhesively-coupled tubes/sleeves, joints, gauges, wires, marine components, other structures/articles, or a combination thereof.

### Examples

In a first example, a comparative example, peel strengths of fluoropolymeric and functionalized fluoropolymeric blends having different concentrations of functionalized fluoropolymeric material were tested on two different materials. As shown in TABLE 1 below, the peel strength of PFA alone (0% functionalized PFA) was too low to test on each of the materials. At concentrations of between 8% and 24% functionalized PFA, measurable peel strengths ranged from 0.85 lbf/in to 1.32 lbf/in, depending on the material the blend was bound to. At 100% functionalized PFA the peel strengths was 1.37 lbf/in.

TABLE 1

| Concentration | Peel Strength | Peel Strength |
|---|---|---|
| of | with balance | with balance |
| functionalized | PFA on | PFA on |
| PFA | MPFA5427* | EA2000* |
| (vol. %) | (in lbf/in) | (in lbf/in) |
| 0 | Too low to test | Too low to test |
| 8 | Too low to test | 0.98 |
| 16 | 0.89 | 1.32 |
| 24 | 0.85 | |
| 100 | 1.37 | |

*MPFA5427 and EA2000 are functionalized PFA

In a second example, according to an embodiment of the disclosure, peel strengths of several adhesive blends including different concentrations of functionalized fluoropolymeric material in 20%, by volume, PEI and a balance PFA were tested on two different materials. As shown in TABLE 2 below, the addition of 8%, by volume, functionalized PFA increased the peel strength of the blend by over 1000% as compared to PEI and PFA alone.

TABLE 2

| Concentration | Peel Strength with | Peel Strength with |
|---|---|---|
| of | 20% PEI and a | 20% PEI and |
| functionalized | balance PFA on | a balance PFA |
| PFA | MPFA5427 | on EA2000 |
| (vol. %) | (in lbf/in) | (in lbf/in) |
| 0 | 1.2 | 1.2 |
| 8 | 25.38 | 21.83 |
| 16 | 30.46 | 19.86 |
| 24 | 34.33 | 22.46 |

In a third example, according to an embodiment of the disclosure, peel strengths of several adhesive blends including different concentrations of functionalized fluoropolymeric material in 20%, by volume, PPS and a balance PFA were tested on two different materials. As shown in TABLE 3 below, the addition of 8%, by volume, functionalized PFA increased the peel strength of the blend by over 300% as compared to PPS and PFA alone.

TABLE 3

| | Peel Strength | Peel Strength |
|---|---|---|
| Concentration | with 20% PPS | with 20% |
| of | and a balance | PPS and a |
| functionalized | PFA on | balance PFA |
| PFA | MPFA5427 | on EA2000 |
| (vol. %) | (in lbf/in) | (in lbf/in) |
| 0 | 8.21 | 8.21 |
| 8 | 28.02 | 25.64 |
| 16 | 28.32 | 27.38 |
| 24 | 28.97 | 26.56 |

In a fourth example, according to an embodiment of the disclosure, peel strengths of several adhesive blends including different concentrations of functionalized fluoropolymeric material in 20%, by volume, PES and a balance PFA were tested on two different materials. As shown in TABLE 4 below, the addition of 8%, by volume, functionalized PFA increased the peel strength on both materials, with the increase in peel strength on EA2000 being greater than that of the increase on MPFA5427.

TABLE 4

| | Peel Strength | Peel Strength |
|---|---|---|
| Concentration | with 20% PES | with 20% PES |
| of | and a balance | and a balance |
| functionalized | PFA on | PFA on |
| PFA | MPFA5427 | EA2000 |
| (vol. %) | (in lbf/in) | (in lbf/in) |
| 0 | 7.37 | 7.37 |
| 8 | 9.53 | 26.98 |
| 16 | 17.03 | 25.39 |
| 24 | 22.48 | 26.88 |

As illustrated in the examples above, in comparison to functionalized fluoropolymeric and fluoropolymeric blends, as well as fluoropolymeric and thermoplastic blends, the adhesives including fluoropolymeric, functionalized fluoropolymeric, and thermoplastic materials have substantially increased peel strength on each of the materials tested. Without wishing to be bound by theory, it is believed that reactions between the functional groups in the thermoplastic materials, such as amine and acid groups in PEI, and the functional groups of the functionalized fluoropolymers, such as the epoxy group in the functionalized PFA, provide the increase in peel strength of the adhesive blend. Additionally or alternatively, and again without wishing to be bound by theory, it is believed that incorporation of the functional fluoropolymers increases the interactions between immiscible fluoropolymers and thermoplastics and/or decreases phase separation of the blends.

In a fifth example, shear strengths of several adhesive blends including different concentrations of functionalized fluoropolymeric material in 20%, by volume, PEI and a balance PFA were tested for bonding PTFE to PTFE. As shown in TABLE 5 below, the shear strength of the blends including the functionalized fluoropolymeric material was the same as or greater than the shear strength of the blends prepared without functionalized fluoropolymeric material (0%).

TABLE 5

| | Shear Strength |
|---|---|
| Concentration | with 20% PEI |
| of | (PTFE/PTFE) |
| functionalized | and a balance |
| PFA (vol. %) | PFA (in MPa) |
| 0 | 2.47 |
| 8 | 2.47 |
| 16 | 2.68 |
| 24 | 2.58 |

As illustrated by the examples above, the addition of functionalized fluoropolymers to adhesive blends including thermoplastics and fluoropolymers increases the peel strength of the adhesive blends without or substantially without decreasing the shear strength of the adhesive blends. Additionally, as will be appreciated by those skilled in the art, while the addition of the functionalized fluoropolymers to the adhesive blends including thermoplastics and fluoropolymers increases the peels strength of the adhesive blends, the addition of the functionalized fluoropolymers to the fluoropolymers alone had little to no effect on peel strength. Accordingly, without wishing to be bound by theory, it is believed that the fluoropolymer, functionalized fluoropolymer, and thermoplastic materials provide a synergistic effect, increasing the peel strength of the adhesive composition by a greater than expected amount based upon the individual properties of the materials. While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. An adhesive arrangement, comprising:
an adhesive formed from an adhesive composition, the adhesive composition having a fluoropolymeric material, a functionalized fluoropolymeric material, and a thermoplastic material; and
a base layer in contact with the adhesive, the base layer being a perfluoropolymeric material, a composite material, a metal material, or a metallic material;
wherein the thermoplastic material is selected from the group consisting of polyamide (PA), polyphenylenesulfide (PPS), polyetheretherketone (PEEK), polyimide (PI), polyimide derivatives such as polyetherimide (PEI), polyaryletherketone (PAEK), polyaryletherketone derivatives, polysulfone, polyethersulfone (PES), polysulfone derivatives, and combinations thereof.

2. The adhesive arrangement of claim 1, wherein the base layer is devoid of surface characteristics from surface treatment.

3. The adhesive arrangement of claim 1, further comprising an adhering layer in contact with the adhesive, the adhesive securing the adhering layer to the base layer.

4. The adhesive arrangement of claim 3, wherein the adhering layer is devoid of surface characteristics from surface treatment.

5. The adhesive arrangement of claim 3, wherein at least one of the base layer and the adhering layer is a metallic material.

6. The adhesive arrangement of claim 3, wherein at least one of the base layer and the adhering layer is a perfluoropolymer.

7. The adhesive arrangement of claim 1, wherein the thermoplastic material is at a concentration, by volume, of between 10% and 50%.

8. The adhesive arrangement of claim 1, wherein the adhesive arrangement has a shear strength of at least 0.5 MPa.

9. The adhesive arrangement of claim 8, wherein the adhesive arrangement has a peel strength of at least 15 lbf/in.

10. The adhesive arrangement of claim 1, wherein the fluoropolymeric material includes perfluoroalkoxy (PFA), fluorinated ethylene propylene (FEP), or a combination thereof.

11. The adhesive arrangement of claim 10, wherein a base polymer of the functionalized fluoropolymeric material is the same as the fluoropolymeric material.

12. The adhesive arrangement of claim 10, wherein a base polymer of the functionalized fluoropolymeric material differs from the fluoropolymeric material.

13. The adhesive arrangement of claim 10, wherein the functionalized fluoropolymeric material is selected from the group consisting of epoxy functionalized fluoropolymeric material, epoxy functionalized perfluoropolymeric material, anhydride functionalized fluoropolymeric material, anhydride functionalized perfluoropolymeric material, and combinations thereof.

14. The adhesive arrangement of claim 1, wherein the adhesive further comprises filler particles selected from the group consisting of reinforcing particles, conductive particles, and a combination thereof.

15. The adhesive arrangement of claim 1, further comprising:
an adhering layer adhesively coupled to the base layer by the adhesive;
wherein the base layer includes one or more materials from the group of polytetrafluoroethylene (PTFE), aluminum, and steel;
wherein the adhering layer includes the one or more materials; and
wherein the adhesive arrangement has a property of peel strength that is at least 100% greater than a relative peel strength of a pure perfluoroalkoxy (PFA) and thermoplastic adhesive arrangement adhesively coupling two relative surfaces of the one or more materials.

16. The adhesive arrangement of claim 1, further comprising an adhering layer adhesively coupled to the base layer by the adhesive, wherein the base layer includes one or more materials from the group of polytetrafluoroethylene (PTFE), aluminum, and steel, and wherein the adhesive arrangement has a property of peel strength that is at least 300% greater than a relative peel strength of a pure perfluoroalkoxy (PFA) and thermoplastic adhesive arrangement adhesively coupling the one or more materials with a material identical to the adhering layer.

17. An adhesive arrangement, comprising:
an adhesive formed from an adhesive composition, the adhesive composition having a fluoropolymeric material, a functionalized fluoropolymeric material, and a thermoplastic material;
a base layer in contact with the adhesive, the base layer being selected from the group consisting of a perfluoropolymeric material, a composite material, a metal material, and a metallic material; and
an adhering layer in contact with the adhesive and secured to the base layer by the adhesive, the adhering layer being selected from the group consisting of a perfluoropolymeric material, a composite material, a metal material, and a metallic material;
wherein the fluoropolymeric material is a melt-processable perfluoropolymeric material that includes perfluoroalkoxy (PFA), fluorinated ethylene propylene (FEP), or a combination thereof.

18. The adhesive arrangement of claim 17, wherein the adhesive arrangement has a peel strength of at least 15 lbf/in.

19. An adhesive arrangement, comprising:
an adhesive formed from an adhesive composition, the adhesive composition having a fluoropolymeric material, a functionalized fluoropolymeric material, and a thermoplastic material; and
a base layer in contact with the adhesive, the base layer being selected from the group consisting of a perfluoropolymeric material, a composite material, a metal material, and a metallic material;
wherein the fluoropolymeric material is a melt-processable perfluoropolymeric material that includes perfluoroalkoxy (PFA), fluorinated ethylene propylene (FEP), or a combination thereof;
wherein the functionalized fluoropolymeric material is selected from the group consisting of epoxy functionalized fluoropolymeric material, epoxy functionalized perfluoropolymeric material, anhydride functionalized fluoropolymeric material, anhydride functionalized perfluoropolymeric material, and combinations thereof;
wherein the thermoplastic material is selected from the group consisting of polyamide (PA), polyphenylenesulfide (PPS), polyetheretherketone (PEEK), polyimide (PI), polyimide derivatives such as polyetherimide (PEI), polyaryletherketone (PAEK), polyaryletherketone derivatives, polysulfone, polyethersulfone (PES), polysulfone derivatives, and combinations thereof; and
wherein the base layer is devoid of surface characteristics from surface treatment.
